(19) United States
(12) Patent Application Publication
(10) Pub. No.: US 2003/0142058 A1
(43) Pub. Date: Jul. 31, 2003

(54) LCD controller architecture for handling fluctuating bandwidth conditions

(76) Inventor: William T. Maghielse, Austin, TX (US)

Correspondence Address: FISH & RICHARDSON, PC, 4350 LA JOLLA VILLAGE DRIVE, SUITE 500, SAN DIEGO, CA, 92122, US

(21) Appl. No.: 10/062,268

(22) Filed: Jan. 31, 2002

(51) Int. Cl. G09G 3/36

(52) U.S. Cl. 345/98

(57) ABSTRACT

Controlling pixel data typically includes determining whether pixel data from an input FIFO is valid. When a determination is made that the pixel data is invalid, the pixel data is discarded so that invalid pixel data is not written to an output FIFO. A token associated with the pixel data may be asserted when the pixel data is valid. The token associated with the pixel data may be deasserted when the pixel data is invalid. Controlling pixel data also may include writing pixel data to an LCD panel from an output FIFO and stalling a pixel clock when the output FIFO does not contain valid pixel data.

### TECHNICAL FIELD

The following description relates to Liquid Crystal Display (LCD) controller architecture for handling fluctuating bandwidth conditions.

### BACKGROUND

Fluctuating bandwidth conditions and/or other conditions may have an adverse affect on a display being shown on an LCD panel. For instance, a fluctuating bandwidth condition may cause a data underrun within the LCD controller. The data underrun condition may cause the LCD panel to become corrupt with bad pixel data such that the display on the LCD panel becomes visually corrupt. Even if the display is not visually corrupt, the LCD panel may not display the image intended to be displayed by a programmer due to the underrun condition. A single underrun while fetching a frame may result in shifting by one or more pixels of the entire frame being displayed on the LCD panel.

### DESCRIPTION OF DRAWINGS

FIG. 1 is a block diagram illustrating a computer system in accordance with an exemplary implementation.

FIG. 2 is a block diagram illustrating an LCD controller in accordance with an exemplary implementation.

FIG. 3 is a flow chart illustrating a process for an input FIFO fill data path in accordance with an exemplary implementation.

FIG. 4 is a flow chart illustrating a process for a data path flow between an input FIFO and an output FIFO in accordance with an exemplary implementation.

FIG. 5 is a flow chart illustrating a process of an output FIFO read data path in accordance with an exemplary implementation.

FIGS. 6 and 7 are timing diagrams.

Like reference symbols in the various drawings indicate like elements.

### DETAILED DESCRIPTION

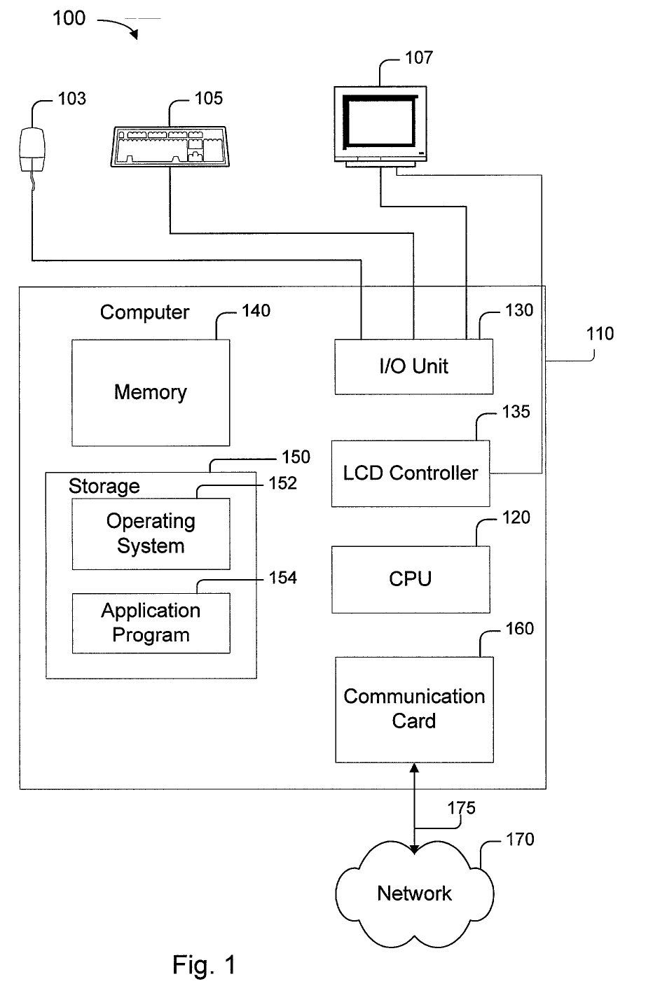

FIG. 1 illustrates an exemplary computer system 100. The system 100 may include various input/output (I/O) devices (e.g., mouse 103, keyboard 105, and display 107) and a general purpose computer 110 having a central processor unit (CPU) 120, an I/O unit 130, memory 140, and storage 150. Storage 150 may store machine-executable instructions, data, and various programs such as an operating system 152 and one or more application programs 154, all of which may he processed by CPU 120.

System 100 also may include a communications card or device 160 (e.g., a modem and/or a network adapter) for exchanging data with a network 170 using a communications link 175 (e.g., a telephone line, a wireless network link, a wired network link, or a cable network). Other examples of system 100 may include a handheld device, a workstation, a server, a device, a component, other equipment, or some combination of these capable of responding to and executing instructions in a defined manner.

Display 107 may include a Liquid Crystal Display (LCD) panel. For example, display 107 may include a flat panel display, a passive flat panel display (e.g., a supertwist nematic (STN) passive matrix LCD or a double-layer supertwist nematic (DSTN) passive matrix LCD), an active flat panel display (e.g., a thin-film transistor (TFT) active matrix LCD), or another type of LCD panel. Display 107 also may include an NTSC (National Television Standards Committee) television.

Display 107 may be set to a specific refresh rate. The refresh rate determines the number of frames per second to be displayed on the display 107. For instance, a refresh rate of 70 Hz means that 70 frames per second will be displayed on the display 107.

A frame provides one image that is to be displayed on the display 107. A single frame may include multiple horizontal lines.

System 100 also may include an LCD controller 135 that provides an interface to display 107. The LCD controller 135 typically controls and manages the processes associated with fetching display data from memory 140 or from some other component within system 100 and processing the display data for viewing on display 107. For example, for an LCD panel set to a refresh rate of 70 Hz, the LCD controller fetches pixel data from the external memory 140 and processes the pixel data to display 70 frames per second on the LCD panel. In another exemplary implementation, LCD controller 135 also may be used to process and drive the display data for an NTSC television.

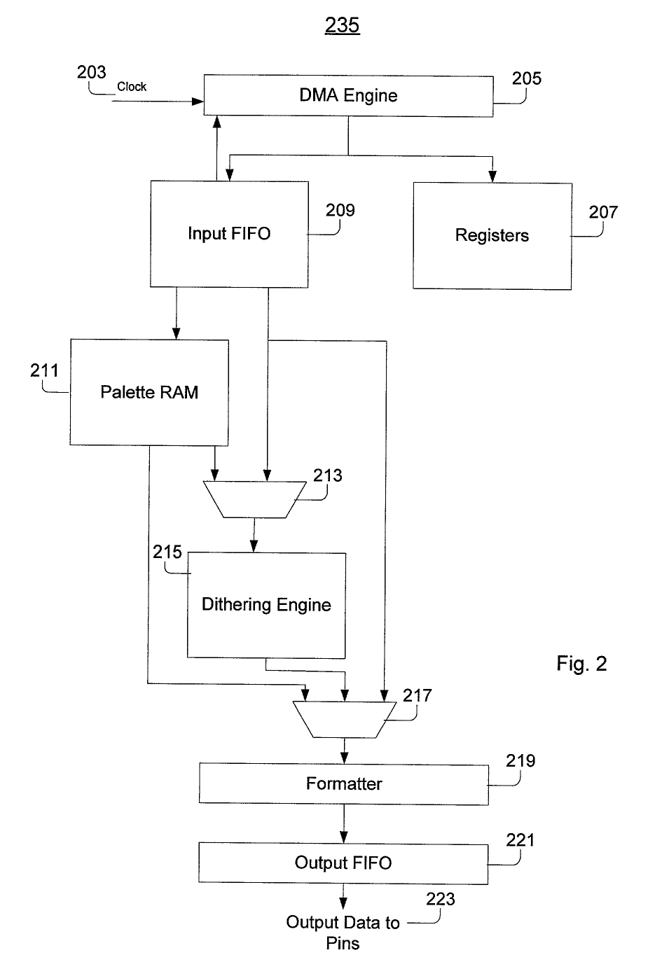

FIG. 2 illustrates an exemplary block diagram of an LCD controller 235. In this implementation, LCD controller 235 typically receives one or more clock signals 203, and includes a Direct Memory Access (DMA) engine 205, one or more registers 207, an input First-In First-Out (FIFO) memory 209, a palette random access memory (RAM) 211, a multiplexor 213, a dithering engine 215, a multiplexor 217, a formatter 219, an output FIFO memory 221, and pins 223 to an LCD panel (e.g., display 107 of FIG. 1).

In general, the DMA engine 205 may be a dedicated DMA engine 205 that fetches pixel data stored in external memory (e.g., memory 140 of FIG. 1). The DMA engine 205 may fetch the pixel data from the external memory on a demand basis. For instance, the DMA engine 205 may receive a request for pixel data from the input FIFO 209 that triggers the DMA engine 205 to fetch the pixel data from the external memory.

In this implementation, the input FIFO 209 includes a request mechanism that sends requests for pixel data to the DMA engine 205 based on the number of entries available in the input FIFO 209. Input FIFO 209 may include one or more input FIFOs that may be structured and arranged to operate in concert. Typically, the request mechanism operates to keep the entries in the input FIFO 209 full.

In general, data that is read from memory and written into the input FIFO 209 overwrites pixel data in the input FIFO 209 that has already been read out of the input FIFO for further processing by the LCD controller.

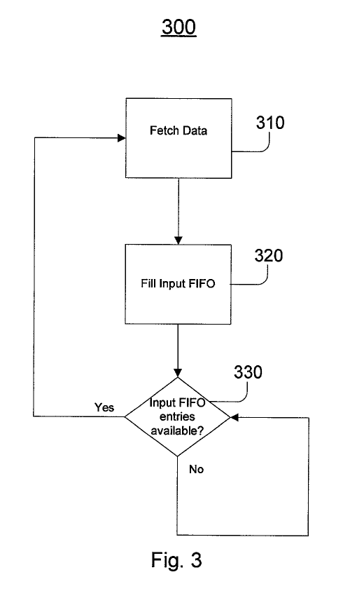

FIG. 3 illustrates an exemplary process 300 for the input FIFO fill data path. Process 300 typically includes requesting that the pixel data be fetched from the external memory (310), filling the input FIFO with the fetched pixel data (320), and determining whether any of the input FIFO entries are available (330). If it is determined that there are entries available, then a request that pixel data be fetched from the external memory is generated (310) to continue filling the input FIFO (320). If it is determined that there are no entries available, then the input FIFO waits until entries are available. As soon as entries are available, then a request that pixel data be fetched from the external memory is generated (310). The number of entries available depends on the size of the input FIFO.

Referring back to FIG. 2, in this example, once the pixel data is written into the input FIFO 209, the pixel data may be used to write to the palette RAM 211, sent to mulitplexor 213 for processing by the dithering engine 215, or sent to multiplexor 217 for processing by the formatter 219. The palette RAM 211 converts pixel data from the input FIFO 209 that is less than 16-bit pixel data to a 16-bit color. In general, if the pixel data from the input FIFO 209 is 1, 2, 4, or 8-bit pixel data, then the pixel data is indexed to the palette RAM 211 to look-up a 16-bit color. If the data written into the input FIFO 209 is 16-bit pixel data, then the palette RAM 211 may be bypassed.

The dithering engine 215 generally is used when the LCD panel is a passive matrix LCD panel. If the LCD panel is a passive matrix display panel, then the 16-bit pixel data from the palette RAM 211 or the 16-bit pixel data from the input FIFO 209 is sent to the dithering engine 215 for dithering. The dithering engine 215 takes a 16-bit encoded pixel and converts the pixel to a 3-bit RGB (red/green/blue) value. If the LCD panel is an active matrix display, then dithering is not needed and the dithering engine 215 may be bypassed.

The formatter 219 receives and formats the data from the multiplexor 217, which pieces together the 3-bit RGB pixels that were processed by the dithering engine 215 or the 16-bit pixels that bypassed the dithering engine 215. The formatter 219 writes the formatted data to the output FIFO 221. In general, the formatter 219 concatenates pixel values to form data suitable for storage in the output FIFO 221. For example, the formatter 219 may concatenate pixel values to form 8-bit or 16-bit output FIFO 221 entries. The size of the entry that the formatter concatenates may depend upon the size of the output FIFO 221. Several pixels from the input FIFO 209 may be assembled by the formatter 219 to form a complete output FIFO entry.

The output FIFO 221 provides data for display to the pins 223 of the LCD panel. The output FIFO 221 includes the processed pixels that are ready for display through pins 223 on the LCD panel. The output FIFO 221 generally is configured to attempt to stay full. In general, the output FIFO 221 determines the number of pixels needed from the input FIFO 209 in order to fill an entry in the output FIFO 221, and includes a request mechanism that makes this determination and sends a request to the input FIFO 209 for the appropriate number of pixels.

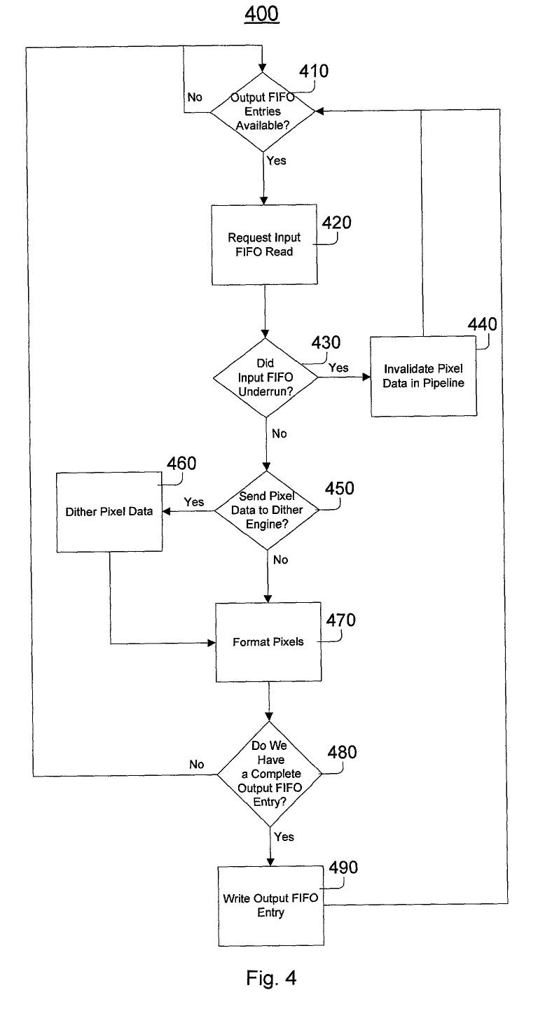

FIG. 4 illustrates an exemplary process 400 for the flow and control of pixel data in the LCD controller. Process 400 typically includes determining whether any output FIFO entries are available (410). If no output FIFO entries are available, then process 400 waits until an output FIFO entry is available. If an output FIFO entry is available, then a read request is sent to the input FIFO (420).

Process 400 then determines whether an underrun occurred in the input FIFO (430). An underrun situation may occur when the output FIFO 221 requests pixel data from the input FIFO (420) and the input FIFO does not have any valid pixel data to send to the output FIFO 221. For example, an underrun situation may occur when all of the entries in the input FIFO have been read, processed, and written into the output FIFO. In this case, the input FIFO may not have been able to fetch additional entries from another system component (e.g., from external memory) due to fluctuating bandwidth conditions or other conditions in the system that may prevent the input FIFO from obtaining pixel data. Typically, when an underrun occurs within the input FIFO, old pixel data may still be available to be read from the input FIFO. However, the old or previously-read pixel data would be invalid because it had been previously sent to the output FIFO.

If an underrun occurs in the input FIFO, then the pixel data is invalidated (440). Invalidating the data (440) prevents bad pixel data from being processed and read into the output FIFO. Thus, bad pixel data that may result from an underrun of the input FIFO would not be displayed on the LCD panel. In this manner, the LCD panel would not display corrupted data caused by an input FIFO underrun.

The pixel data may be invalidated (440) by associating a token or other identifier with the pixel data to indicate whether the data is valid or invalid. For example, if the token associated with pixel data from the input FIFO is asserted, then the pixel data is valid and may be processed for writing into the output FIFO for display on the LCD panel. If the token associated with pixel data from the input FIFO is deasserted, then the pixel data is invalid and should be discarded prior to being written into the output FIFO so that the invalid pixel data is not displayed on the LCD panel.

Alternatively, the pixel data may be invalidated (440) by stalling a clock associated with the LCD controller until the input FIFO contains valid pixel data obtained from the external memory. For example, if an underrun occurs in the input FIFO (430), then the LCD controller clock that clocks the flow of pixel data from the input FIFO to the output FIFO is stalled so that no pixel data is processed and written into the output FIFO until valid pixel data is available from the input FIFO.

If an input FIFO underrun has not occurred (430), then process 400 determines whether to send the pixel data from the input FIFO to the dithering engine (450). The pixel data typically is sent to the dithering engine (460) when the LCD panel is a passive matrix LCD panel. After dithering the pixel data (460), the pixel data is sent to the formatter to be formatted (470).

The dithering engine may be bypassed and the pixel data may be sent to the formatter to be formatted (470), when the LCD panel is a panel that does not require dithering. For example, if the LCD panel is an active matrix LCD panel, then the dithering engine is bypassed and the pixel data is sent to the formatter to be formatted (470). When an input FIFO underrun occurs (430) and the pixel data flowing from the input FIFO is invalidated (440), then the dithering engine may maintain its current state in the dither algorithm (e.g., maintain its counters) until valid pixel data is received.

Process 400 also includes formatting the pixels (470), for example, by concatenating pixel data received at the formatter to form 8-bit or 16-bit output FIFO entries. Process 400 also includes determining whether a complete output FIFO entry is available (480). If a complete output FIFO entry is assembled by the formatter, then the entry is written to the output FIFO (490). If a complete entry is not assembled, and there is an available output FIFO entry in which to write (410), a request is sent to read the next pixel data from the input FIFO (420).

When a request for pixel data is sent to the input FIFO (420), the output FIFO may use one or more pointers or other markers to track the status of the request. For example, the output FIFO may use a pointer to associate a specific request of the input FIFO with a designated available entry in the output FIFO. The output FIFO maintains the pointer with the designated entry until valid pixel data is received from the input FIFO (e.g., pixel data with the token asserted to indicate the pixel data is valid). Any data that is not valid is discarded (e.g., pixel data with the token deasserted to indicate the pixel data is invalid) and the pointer remains associated with that available entry until valid pixel data is received.

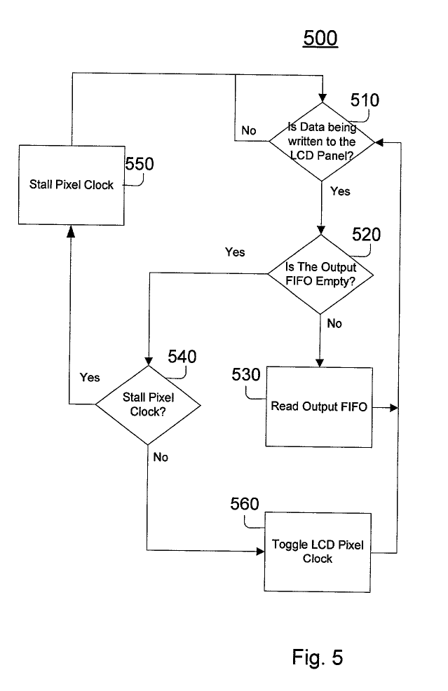

FIG. 5 illustrates an exemplary process 500 of the output FIFO read data path. Process 500 typically includes determining whether pixel data is currently being written to the LCD panel (510). If pixel data is not being written to the LCD panel, the process 500 waits until pixel data is being written to the LCD panel. If pixel data is being written to the LCD panel, then process 500 determines whether the output FIFO is empty (520).

If it is determined that the output FIFO is not empty (520), then the output FIFO is read and the pixel data is sent from the output FIFO to the LCD panel for display (530).

If it is determined that the output FIFO is empty (520), then an underrun condition exists at the output FIFO. An underrun condition at the output FIFO occurs when valid pixel data is not available to read from the output FIFO for display on the LCD panel. Without being corrected, an underrun condition at the output FIFO in a typical LCD controller causes each frame being delivered to the LCD panel to be shifted by one or more pixels for each underrun on each line included in the frame.

Process 500 alleviates the effects of an underrun at the output FIFO. If an underrun condition exists at the output FIFO, the condition may be alleviated by determining whether to stall the pixel clock (540). Typically, the pixel clock may be stalled based on the type of LCD panel being used. If the LCD panel is of a type that can tolerate stalling the pixel clock, then the pixel clock is stalled until the output FIFO contains valid pixel data to be written to the LCD panel (550). Stalling the pixel clock (550) prevents invalid pixel data from being displayed on the LCD panel and masks output FIFO underruns.

If the LCD panel is of a type that cannot tolerate stalling the pixel clock, then the LCD pixel clock is continuously toggled to repeat old pixel data on the data pins until the output FIFO underrun condition clears (560). The data pins are updated when the underrun condition clears and new pixel data is available in the output FIFO. Any extra clock cycles resulting from the underrun are kept on the same line within a frame. The LCD controller does not start the next line of the frame until the correct valid pixel data is available from the output FIFO. In this manner, an output FIFO underrun may only corrupt one line of a frame with invalid pixel data instead of corrupting the entire frame, as is common with other LCD controllers.

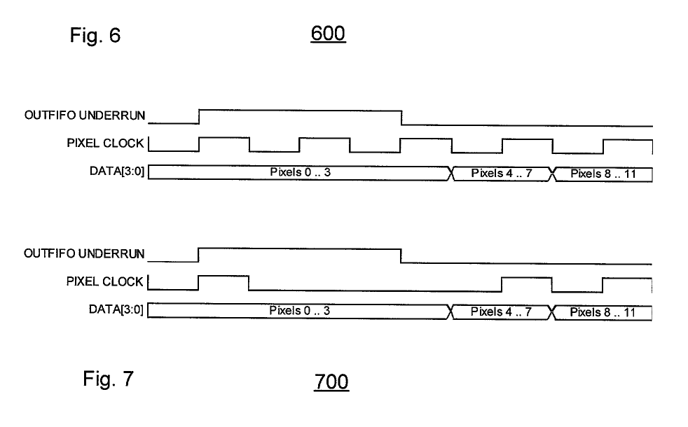

FIG. 6 illustrates an exemplary timing diagram 600 that illustrates continuously toggling the LCD pixel clock with the same pixel data (560) until the output FIFO underrun clears. In this example, when the output FIFO underrun occurs, the pixel clock continues to clock and repeat old data on the data pins for the duration of the output FIFO underrun. In this case, pixels 0 . . . 3 are continuously repeated until the output FIFO underrun clears. When the output FIFO underrun clears, then the new pixel data (pixels 4 . . . 7, 8 . . . 1) are sent to the data pins.

FIG. 7 illustrates an exemplary timing diagram 700 that illustrates stalling the pixel clock (550) when the output FIFO is empty (520). In this example, when the output FIFO underrun occurs, the pixel clock is stalled and pixel data is not provided to the data pins during the output FIFO underrun. When the output FIFO underrun clears, then the new pixel data (pixels 4 . . . 7, 8 . . . 1) are sent to the data pins.

The described systems, methods, and techniques may be implemented in digital electronic circuitry, computer hardware, firmware, software, or in combinations of these elements. Apparatus embodying these techniques may include appropriate input and output devices, a computer processor, and a computer program product tangibly embodied in a machine-readable storage device for execution by a programmable processor.

A process embodying these techniques may be performed by a programmable processor executing a program of instructions to perform desired functions by operating on input data and generating appropriate output data. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

It will be understood that various modifications may be made. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A method of controlling pixel data, the method comprising:
determining whether pixel data from an input FIFO (First-In First-Out) is valid; and
when a determination is made that the pixel data is invalid, discarding the pixel data so that invalid pixel data is not written to an output FIFO.

2. The method of claim 1 further comprising requesting the pixel data from the input FIFO.

3. The method of claim 1 further comprising:
when a determination is made that the pixel data is valid, processing the pixel data so that valid pixel data is written to the output FIFO; and
writing the valid pixel data to the output FIFO.

4. The method of claim 1 further comprising:
asserting a token associated with the pixel data when the pixel data is valid; and
deasserting the taken associated with the pixel data when the pixel data is invalid.

5. The method of claim 1 wherein when the determination is made that the pixel data is invalid, stalling a clock so that invalid pixel data is not written to the output FIFO.

6. The method of claim 1 further comprising when the determination is made that the pixel data is invalid, maintaining a current state in a dithering engine until valid pixel data is available from the input FIFO.

7. The method of claim 1 further comprising when the determination is made that the pixel data is invalid, maintaining a current state in a formatter until valid pixel data is available from the input FIFO.

8. A machine-accessible medium that when accessed, results in a machine performing operations comprising:
determining whether pixel data from an input FIFO (First-In First-Out) is valid; and
when a determination is made that the pixel data is invalid, discarding the pixel data so that invalid pixel data is not written to an output FIFO.

9. The machine-accessible medium of claim 8 wherein:
the machine includes a computer that performs the operations, and
the machine-accessible medium includes a computer-readable medium having stored thereon one or more sequences of instructions for causing the computer to perform the operations.

10. The machine-accessible medium of claim 8 further comprising requesting the pixel data from the input FIFO.

11. The machine-accessible medium of claim 8 further comprising:
when a determination is made that the pixel data is valid, processing the pixel data so that valid pixel data is written to the output FIFO; and
writing the valid pixel data to the output FIFO.

12. The machine-accessible medium of claim 8 further comprising:
asserting a token associated with the pixel data when the pixel data is valid; and
deasserting the token associated with the pixel data when the pixel data is invalid.

13. The machine-accessible medium of claim 8 wherein when the determination is made that the pixel data is invalid, stalling a clock so that invalid pixel data is not written to the output FIFO.

14. The machine-accessible medium of claim 8 further comprising when the determination is made that the pixel data is invalid, maintaining a current state in a dithering engine until valid pixel data is available from the input FIFO.

15. The machine-accessible medium of claim 8 further comprising when the determination is made that the pixel data is invalid, maintaining a current state in a formatter until valid pixel data is available from the input FIFO.

16. A method of controlling pixel data, the method comprising:
writing pixel data to a Liquid Crystal Display (LCD) panel from an output FIFO (First-In First-Out); and
stalling a pixel clock when the output FIFO does not contain valid pixel data.

17. The method of claim 16 further comprising clocking the pixel clock when the output FIFO contains valid pixel data.

18. The method of claim 16 wherein the LCD panel includes a passive matrix LCD panel.

19. The method of claim 16 wherein the LCD panel includes an active matrix LCD panel.

20. A method of controlling pixel data, the method comprising:
writing pixel data to a Liquid Crystal Display (LCD)panel from an output FIFO (First-In First-Out); and
continuously clocking a pixel clock with previously written pixel data that are added to an end of a line on the LCD panel when the output FIFO does not contain valid pixel data until the output FIFO contains valid pixel data.

21. The method of claim 20 wherein the LCD panel includes an active matrix LCD panel.

22. The method of claim 20 wherein the LCD panel includes a passive matrix LCD panel.

23. An apparatus, comprising:
a Direct Memory Access (DMA) engine that is adapted to fetch pixel data;
an input FIFO (First-In First-Out) that is adapted to receive the pixel data from the DMA engine and to indicate whether the pixel data requested from the input FIFO is valid or invalid; and
an output FIFO that is adapted to request the pixel data from the input FIFO, to receive the valid pixel data, and to discard the invalid pixel data.

24. The apparatus of claim 23 further comprising a formatter that is adapted to format the pixel data requested from the input FIFO that is indicated as valid pixel data and to disregard the pixel data that is indicated as invalid pixel data.

25. The apparatus of claim 23 wherein the input FIFO is adapted to assert a token associated with the requested pixel data when the requested pixel data is valid and to deassert the token associated with the requested pixel data when the requested pixel data is invalid.

26. The apparatus of claim 23 further comprising a pixel clock that is adapted to stall when the requested pixel data is invalid.

27. The apparatus of claim 23 further comprising a pixel clock that is adapted to stall when the output FIFO does not contain valid pixel data.

28. The apparatus of claim 23 further comprising a pixel clock that is adapted to continuously clock previously written pixel data to an end of a line on an LCD panel when the output FIFO does not contain valid pixel data.

29. A system, comprising:
a memory that includes pixel data;
a Liquid Crystal Display (LCD) panel; and
a controller that includes:
a Direct Memory Access (DMA) engine that is adapted to fetch the pixel data from the memory;
an input FIFO (First-In First-Out) that is adapted to receive the pixel data from the DMA engine and to indicate whether the pixel data requested from the input FIFO is valid or invalid; and
an output FIFO that is adapted to request the pixel data from the input FIFO, to receive the valid pixel data, to discard the invalid pixel data, and to write the valid pixel data to the LCD panel.

30. The system of claim 29 further comprising a formatter that is adapted to format the pixel data requested from the input FIFO that is indicated as valid pixel data and to disregard the pixel data that is indicated as invalid pixel data.

31. The system of claim 29 wherein the input FIFO is adapted to assert a token associated with the requested pixel data when the requested pixel data is valid and to deassert the token associated with the requested pixel data when the requested pixel data is invalid.

32. The system of claim 29 further comprising a pixel clock that is adapted to stall when the requested pixel data is invalid.

33. The system of claim 29 further comprising a pixel clock that is adapted to stall when the output FIFO does not contain valid pixel data.

34. The system of claim 29 further comprising a pixel clock that is adapted to continuously clock previously written pixel data to an end of a line on the LCD panel when the output FIFO does not contain valid pixel data.
